(19) United States
(12) Patent Application Publication
(10) Pub. No.: US 2025/0131482 A1
(43) Pub. Date: Apr. 24, 2025

(54) GENERATING A CONSTRAINED ORDER BASED ON A FREE-TEXT QUERY USING A LARGE LANGUAGE MODEL

(71) Applicant: Maplebear Inc., San Francisco, CA (US)

(72) Inventors: Chakshu Ahuja, San Jose, CA (US); Karuna Ahuja, San Francisco, CA (US); Radhika Goel, San Francisco, CA (US)

(21) Appl. No.: 18/490,683

(22) Filed: Oct. 19, 2023

(51) Int. Cl. G06Q 30/0601; G06F 16/2457

(52) U.S. Cl. CPC G06Q 30/0627; G06F 16/24578

(57) ABSTRACT

An online concierge system receives a free-text query describing items and constraints from a client device associated with a user. The system generates a prompt including the query and a request to identify the items and constraints. The system provides the prompt to a large language model, extracts, from an output of the model, the constraints and one or more categories associated with the items, and identifies retailers based on user data associated with the user. For each retailer, the system identifies a set of items associated with each category, determines, based on the constraints, a combination of a subset of items associated with each category, and computes a score for the combination based on the user data and item data associated with items in the combination. The system ranks the combinations based on the scores and sends information describing a ranked set of the combinations to the client device.

### BACKGROUND

Online concierge systems allow customers to place online delivery orders and match the orders with pickers who service the orders on behalf of the customers (e.g., by driving to retailer locations, collecting items included in the orders, and delivering the orders to the customers). Items included in each order may be collected from a retailer location based on a retailer specified by a customer who placed the order. For example, when accessing an online concierge system, a customer may select a retailer from a list of retailers associated with the online concierge system and add items to a shopping list for the retailer. In this example, once the customer places an order including the items in their shopping list, the order may be assigned to a picker who may collect the items from a retailer location operated by the retailer.

While online concierge systems provide customers with the convenience of ordering a variety of items from a variety of retailers, customers may find it difficult or time-consuming to compare items and retailers. For example, suppose that a customer is shopping for three items that they need within the next three hours, that the customer wants to spend the least amount possible, and that the customer is brand and retailer agnostic. In this example, if several retailers are associated with an online concierge system, since the delivery timeframes for orders placed with different retailers may vary (e.g., based on the availability and locations of pickers, the distance between retailer locations and the delivery location, etc.), the customer may first identify retailers associated with delivery timeframes within the next three hours. In the above example, for each retailer identified by the customer, the customer may search for different brands, varieties, sizes, etc. of each item to determine its availability and lowest price. Continuing with the above example, the customer may then determine a lowest-priced combination of the three items available at each retailer, compare the prices of these combinations for the identified retailers, and select a retailer associated with the overall lowest-priced combination. As such, customers may find it difficult or time-consuming to compare items they would like to order or retailers with which to place the orders, which may negatively impact their experience with online concierge systems.

### SUMMARY

In accordance with one or more aspects of the disclosure, an online concierge system determines and ranks combinations of items for retailers associated with the online concierge system based on a free-text query. More specifically, an online concierge system receives a free-text query from a client device associated with a user, in which the query describes one or more items included among inventories of retailers associated with the online concierge system and a set of constraints. The online concierge system generates a prompt including the query and a request to identify the item(s) and set of constraints, provides the prompt to a large language model, and extracts, from a textual output of the model, the set of constraints and one or more item categories associated with the item(s). The online concierge system then identifies retailers based on user data associated with the user. For each identified retailer, the online concierge system identifies a set of items associated with each item category, in which the set of items is included among an inventory of a corresponding retailer. For each identified retailer, the online concierge system also determines, based on the set of constraints, a combination of items including a subset of the set of items associated with each item category. The online concierge system then computes a score for the combination of items determined for each identified retailer based on the set of user data and a set of item data associated with each item included in the combination. The online concierge system ranks the combinations of items determined for the retailers based on their scores and sends information describing a ranked set of the combinations of items for display to the client device associated with the user.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for determining and ranking combinations of items for retailers associated with an online concierge system based on a free-text query, in accordance with one or more embodiments.

FIG. 4A is an interaction diagram for determining and ranking combinations of items for retailers associated with an online concierge system based on a free-text query, in accordance with one or more embodiments.

FIG. 4B illustrates an example of determining combinations of items for retailers associated with an online concierge system based on a free-text query, in accordance with one or more embodiments.

FIG. 5 illustrates an example of a ranked set of combinations of items, in accordance with one or more embodiments.

### DETAILED DESCRIPTION

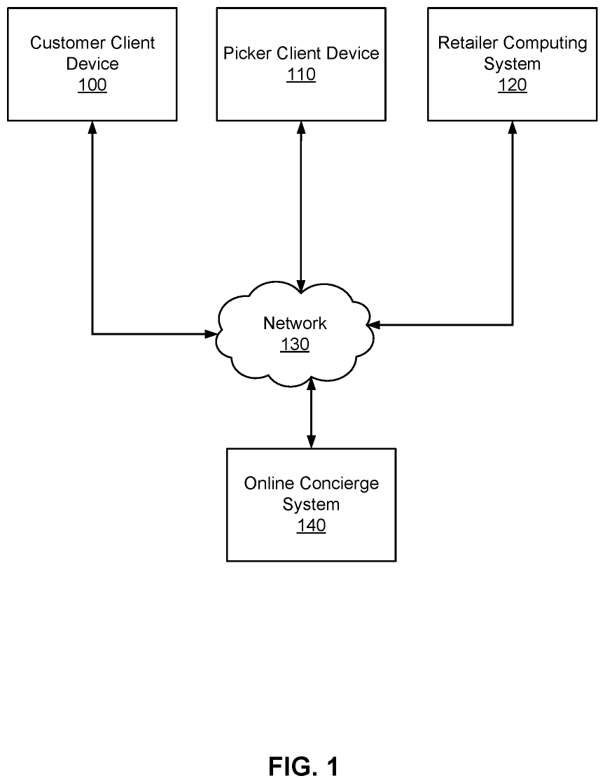

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or a desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, refers to a good or product that may be provided to the customer through the online concierge system 140. The order may include item identifiers (e.g., a stock keeping unit or a price look-up code) for items to be delivered to the customer and may include quantities of the items to be delivered. Additionally, an order may further include a delivery location to which the ordered items are to be delivered and a timeframe during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the customer has selected for an order but that has not yet been finalized for an order. The ordering interface allows a customer to update the shopping list, e.g., by changing the quantity of items, adding or removing items, or adding instructions for items that specify how the items should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the customer to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer location. The picker client device 110 presents the items that are included in the customer's order to the picker in a collection interface. The collection interface is a user interface that provides information to the picker identifying items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 provides instructions to a picker for delivering the items for a customer's order. For example, the picker client device 110 displays a delivery location from the order to the picker. The picker client device 110 also provides navigation instructions for the picker to travel from the retailer location to the delivery location. If a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140. Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 may provide item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a customer's order (e.g., as a commission).

The customer client device 100, the picker client device 110, the retailer computing system 120, and the online concierge system 140 may communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

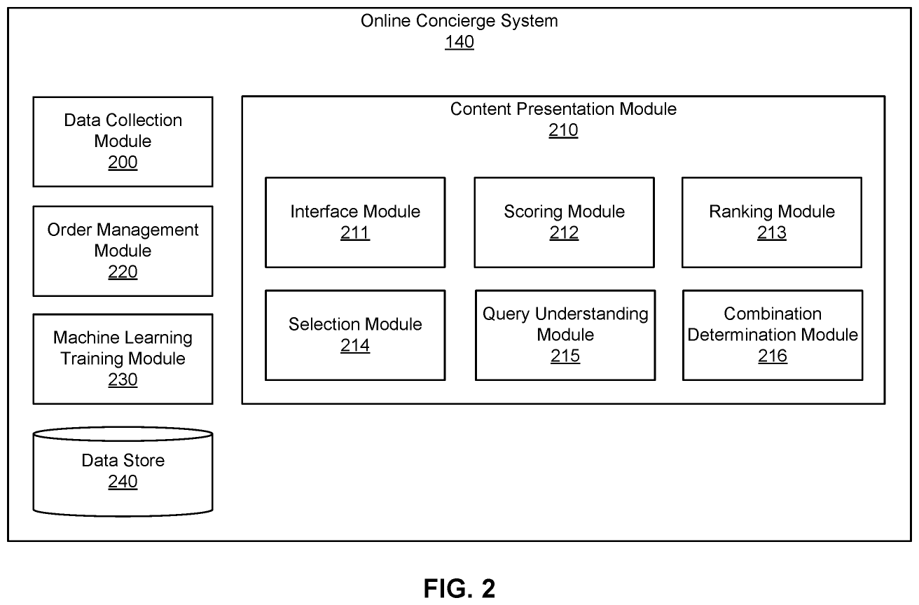

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provide portions of the payment from the customer to the picker and the retailer. As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

The data collection module 200 collects customer data, which is information or data describing characteristics of a customer. Customer data may include a customer's name, location (e.g., address or delivery location), stored payment instruments, preferences/restrictions, or interests (e.g., hobbies). For example, customer data may include a customer's dietary preferences/restrictions (e.g., for items that are vegetarian and that do not contain soy or lactose) and for items having certain attributes (e.g., organic and environmentally-friendly items). As an additional example, customer data may include a customer's shopping preferences, such as the customer's preferred or favorite items or retailers or the customer's preference to purchase certain types of items in bulk or from certain retailers. Customer data also may include demographic information associated with a customer (e.g., age, gender, geographical region, etc.) or household information associated with the customer (e.g., a number of people in the customer's household, whether the customer's household includes children or pets, etc.). The customer data also may include default settings established by a customer, such as a default retailer/retailer location, payment instrument, delivery location, delivery timeframe, or tip amount (e.g., a percentage or a dollar amount).

Customer data also may include information describing a customer's interactions. Examples of such types of information include: queries received from a customer client device 100 associated with the customer, items added to a shopping list associated with the customer, orders placed by the customer, etc. Additionally, customer data may include historical information (e.g., historical order or interaction information) associated with a customer. For example, customer data may describe previous orders placed by a customer with the online concierge system 140 or previous purchases made by the customer at retailer locations. As an additional example, customer data may describe previous interactions by a customer with items or other content (e.g., coupons, recipes, or advertisements) presented by the online concierge system 140. In the above example, the information may describe the items/content (e.g., item types, discounts associated with coupons with which the customer interacted, etc.), the types of interactions (e.g., adding items to a shopping list, searching for items, clicking on an advertisement, etc.), and the times of the interactions (e.g., a timestamp associated with each interaction).

Customer data also may include additional types of information, such as information that is derived from other customer data. For example, based on historical order information associated with a customer, customer data associated with the customer may include a frequency with which the customer orders items of a particular brand, a percentage of items the customer orders that are on sale, types of items that the customer orders from a particular retailer, types of items for which the customer is brand or retailer agnostic, etc. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. The item data also may include information describing one or more retailers or one or more retailer locations associated with an item. For example, the item data may include information identifying a retailer that operates a retailer location at which an item is available and an address or a geographical region associated with the retailer location. Additionally, item data may also include attributes of items such as the sizes, colors, weights, stock keeping units (SKUs), serial numbers, prices, item categories, brands, qualities (e.g., freshness, ripeness, etc.), ingredients, materials, manufacturing locations, versions/varieties (e.g., flavors, low fat, gluten-free, organic, etc.), or any other suitable attributes of the items. For example, for each item-retailer combination (a particular item at a particular retailer location), the item data may include a price of the item at the retailer location, in which the price may indicate whether any sales, coupons, membership discounts, promotions (e.g., bulk discounts), etc. are associated with the price. The item data may further include purchasing rules associated with each item, if they exist. For example, age-restricted items such as alcohol and tobacco are flagged accordingly in the item data. Item data may also include information that is useful for predicting the availability of items at retailer locations. For example, for each item-retailer combination, the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or a customer client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. In some embodiments, item categories may be broader in that the same item category may include item types that are related to a common theme, found in the same department, etc. For example, items such as soy sauce, ramen, and miso soup may be included in an “Asian foods” item category. Furthermore, in various embodiments, an item may be included in multiple categories. For example, organic strawberries may be included in an “organic strawberries” item category, a “strawberries” item category, and an “organic fruit” item category. The item categories may be human-generated and human-populated with items. The item categories also may be generated automatically by the online concierge system 140 (e.g., using a clustering algorithm).

The data collection module 200 also collects picker data, which is information or data describing characteristics of pickers. For example, the picker data for a picker may include the picker's name, the picker's location, how often the picker has serviced orders for the online concierge system 140, a customer rating for the picker, the retailers from which the picker has collected items, or the picker's previous shopping history. Additionally, the picker data may include preferences expressed by a picker, such as their preferred retailers for collecting items, how far they are willing to travel to deliver items to a customer, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data describing characteristics of an order. For example, order data may include item data for items that are included in the order, a delivery location for the order, a customer associated with the order, a retailer location from which the customer wants the ordered items collected, or a timeframe within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. Components of the content presentation module 210 include: an interface module 211, a scoring module 212, a ranking module 213, a selection module 214, a query understanding module 215, and a combination determination module 216, which are further described below.

The interface module 211 generates and transmits an ordering interface for a customer to order items. The interface module 211 populates the ordering interface with items that the customer may select for adding to their order. In some embodiments, the interface module 211 presents a catalog of all items that are available to the customer, which the customer can browse to select items to order. Other components of the content presentation module 210 may identify items that the customer is most likely to order and the interface module 211 may then present those items to the customer. For example, the scoring module 212 may score items and the ranking module 213 may rank the items based on their scores. In this example, the selection module 214 may select items with scores that exceed some threshold (e.g., the top n items or the p percentile of items) and the interface module 211 then displays the selected items.

The scoring module 212 may use an item selection model to score items for presentation to a customer. An item selection model is a machine learning model that is trained to score items for a customer based on item data for the items and customer data for the customer. For example, the item selection model may be trained to determine a likelihood that a customer will order an item. As an additional example, the item selection model may be trained to predict a likelihood that a customer will add an item to a shopping list associated with the customer. In some embodiments, the item selection model uses item embeddings describing items and customer embeddings describing customers to score items. These item embeddings and customer embeddings may be generated by separate machine learning models and may be stored in the data store 240.

In some embodiments, the scoring module 212 scores items based on a search query received from the customer client device 100. A search query is text for a word or set of words that indicate items of interest to the customer. The scoring module 212 scores items based on a relatedness of the items to the search query. For example, the scoring module 212 may apply natural language processing (NLP) techniques to the text in the search query to generate a search query representation (e.g., an embedding) that represents characteristics of the search query. The scoring module 212 may use the search query representation to score candidate items for presentation to a customer (e.g., by comparing a search query embedding to an item embedding).

In some embodiments, the scoring module 212 scores items based on a predicted availability of an item. The scoring module 212 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The scoring module 212 may weight the score for an item based on the predicted availability of the item. Alternatively, items may be filtered out from presentation to a customer based on whether the predicted availability of the item exceeds a threshold.

In addition to computing scores for individual items, the scoring module 212 also may compute scores for combinations of items determined for retailers by the combination determination module 216 (described below), in which the score for a combination of items indicates a likelihood of conversion by a customer for the combination of items. For example, a score for a combination of items determined for a retailer may indicate a likelihood that a customer will add the combination of items to a shopping list associated with the customer for the retailer or place an order including the combination of items with the retailer. The scoring module 212 may compute a score for a combination of items determined for a retailer based on a set of customer data associated with a customer, a set of item data associated with each item included in the combination of items, or any other suitable types of information. For example, suppose that based on customer data associated with a customer and item data associated with items included in a first combination of items determined for a first retailer, the first combination of items includes popular items, sale items, and the customer's favorite brands of items, and the first retailer is one of the customer's preferred retailers. In the above example, suppose also that based on the customer data associated with the customer and item data associated with items included in a second combination of items determined for a second retailer, the second combination of items does not include popular items, sale items, or any of the customer's favorite brands of items, and the second retailer is not one of the customer's preferred retailers. Continuing with the above example, based on the customer data associated with the customer and the item data associated with each item included among the combinations of items, the scoring module 212 may compute a higher score for the first combination of items determined for the first retailer than for the second combination of items determined for the second retailer.

In some embodiments, the scoring module 212 may compute a score for a combination of items determined for a retailer using the item selection model described above. To do so, the scoring module 212 may use the item selection model to predict a likelihood of conversion by a customer for each item included in the combination of items based on a set of customer data associated with the customer, a set of item data associated with the item, or any other suitable types of information. The scoring module 212 may then compute the score for the combination of items based on the predicted likelihood associated with each item. For example, the scoring module 212 may apply the item selection model to a set of preferences and an order history associated with a customer and a brand, an item category, a price, a name of a retailer, etc. associated with an item included in a combination of items. In this example, the scoring module 212 may then receive an output from the item selection model describing a predicted likelihood that the customer will add the item to a shopping list associated with the customer for the retailer. Continuing with this example, the scoring module 212 may repeat this process for each additional item included in the combination of items. In the above example, the scoring module 212 may then compute a score for each item that is proportional to the likelihood predicted for the item and compute a score for the combination of items by aggregating the scores for the items (e.g., as an average or a sum). Alternatively, in the above example, the scoring module 212 may aggregate the likelihoods predicted for the items (e.g., as an average or a sum) and compute the score for the combination of items based on the aggregated predicted likelihoods, such that the score is proportional to the aggregate.

In embodiments in which the item selection model uses item embeddings describing items and customer embeddings describing customers to score items, the scoring module 212 computes a score for a combination of items determined for a retailer using the embeddings. The scoring module 212 may compute a customer embedding for a customer (e.g., using a machine learning model) based on a set of customer data associated with the customer (e.g., information describing the customer's household, default delivery location and delivery timeframe, dietary preferences/restrictions, order and interaction history, favorite items and retailers, etc.).

Similarly, the scoring module 212 may compute an item embedding for each item included in a combination of items determined for a retailer (e.g., using a machine learning model) based on a set of item data associated with the item (e.g., an item category, a price, a brand, etc. associated with the item, information describing the retailer that operates a retailer location at which the item is available, etc.). The scoring module 212 may then determine a measure of similarity between the customer embedding and the item embedding for each item included in the combination of items (e.g., based on a cosine similarity, a Euclidean distance, a dot product, etc.), aggregate the measures of similarity, and compute the score for the combination of items based on the aggregate. For example, the scoring module 212 may compute a dot product of the customer embedding and the item embedding for each of three items included in a combination of items determined for a retailer and compute a sum of the three dot products. In this example, the scoring module 212 may compute the score for the combination of items based on the sum, such that the score is proportional to the sum.

The scoring module 212 also may compute a score for a combination of items determined for a retailer based on a predicted availability of an item included among the combination of items. The scoring module 212 may predict an availability of an item using the availability model described above and compute a score for a combination of items based on the predicted availability of each item included in the combination of items. For example, to compute a score for a combination of items determined for a retailer, the scoring module 212 may apply the availability model to item data associated with each item included in the combination of items to predict its availability at a retailer location operated by the retailer (e.g., a likelihood that the item is available at the retailer location or an estimated number of the item available at the retailer location). In this example, the scoring module 212 may compute the score for the combination of items based on the predicted availability of each item included in the combination of items (e.g., by weighting the score for each item based on its predicted availability and aggregating the weighted scores).

Additionally, the scoring module 212 may compute a score for a combination of items determined for a retailer based on whether a replacement item is included among the combination of items. For example, suppose that an item category extracted by the query understanding module 215 (described below) corresponds to “organic celery” and that a combination of items determined for a retailer includes non-organic celery as a substitute item. In this example, the scoring module 212 may compute a lower score for the combination of items than it would if the combination of items were to include an item associated with the “organic celery” item category since the combination of items includes a substitute item. Alternatively, in the above example, if the combination of items does not include an item associated with the “organic celery” item category or a substitute (e.g., if a substitute is not available), the scoring module 212 may compute an even lower score for the combination of items determined for the retailer.

The scoring module 212 also may compute a score for a combination of items determined for a retailer based on a total price associated with the combination of items. A total price associated with a combination of items may include various values, such as a sum of the prices of the items, an amount of tax on the items, a service fee, a delivery fee, a tip amount, etc. The scoring module 212 may compute a total price associated with a combination of items based on item data associated with each item included in the combination of items (e.g., a price of each item, information describing a retailer location at which each item is available, etc.) and customer data associated with a customer (e.g., an address, a geographical region, or a delivery location associated with the customer). The scoring module 212 also may compute a total price associated with a combination of items based on a set of rules, policies, rates, etc. stored in the data store 240 describing how service fees, delivery fees, and taxes are computed, or based on any other suitable types of information.

To illustrate an example of how the scoring module 212 may compute a score for a combination of items determined for a retailer based on a total price associated with the combination of items, suppose that the scoring module 212 computes the total price as a sum of: the prices of the items, an amount of tax on the items, a service fee, a delivery fee, and a tip amount. In this example, the prices of the items may be determined based on item data associated with the items, while the amount of tax may be computed based on a sum of the prices of the items and a tax rate for an address/geographical region associated with a customer or a retailer location operated by the retailer. In the above example, the service fee or the delivery fee may be computed based on various factors, such as a distance between a delivery location associated with the customer and a retailer location operated by the retailer, the sum of the prices, the price of any additional items included in a shopping list associated with the customer for the retailer, etc., which may be proportional to the service fee or the delivery fee. Continuing with this example, if the service fee or the delivery fee may be lower for orders that may be included in a batch than for orders that may not be included in a batch, the service fee or the delivery fee also may be computed based on whether an order including the combination of items may be included in a batch. In this example, the tip amount (e.g., a percentage or a dollar amount) may correspond to or be computed based on a suggested tip amount or a default tip amount specified by the customer data associated with the customer. Continuing with the above example, the scoring module 212 may then compute the score for the combination of items based on the total price, such that the score is inversely proportional to the total price.

In addition to ranking individual items based on their scores, as described above, the ranking module 213 also may rank combinations of items determined for retailers. The ranking module 213 may do so based on scores computed for the combinations of items. For example, the ranking module 213 may rank combinations of items based on their scores, such that a combination of items with a highest score is ranked first, a combination of items with a second-highest score is ranked second, etc. The ranking module 213 also may rank combinations of items determined for retailers based on additional factors. In some embodiments, the ranking module 213 ranks combinations of items based on a weight applied to a score associated with a combination of items. The ranking module 213 may weight a score for a combination of items based on whether an order including the combination of items may be included in a batch of orders. For example, if an order may be included in a batch of orders if it includes a first combination of items determined for a first retailer, but not if it includes a second combination of items determined for a second retailer, the ranking module 213 may weight a score for the first combination of items more heavily than a score for the second combination of items.

Once the ranking module 213 ranks combinations of items determined for retailers, the selection module 214 may select a ranked set of the combinations of items. The selection module 214 may do so based on the ranking (e.g., the top n combinations of items or the p percentile of combinations of items). The selection module 214 also may select a ranked set of combinations of items based on predicted availabilities of items included in each combination of items (e.g., determined by the scoring module 212, as described above, or by the combination determination module 216, as described below). Based on the predicted availabilities, the selection module 214 may determine a percentage of items included in each combination of items determined for a corresponding retailer associated with at least a threshold predicted availability at a retailer location operated by the retailer. The selection module 214 may then select a ranked set of the combinations of items based on the percentage. For example, the selection module 214 may select five of the top-ranked combinations of items determined for retailers, in which less than 10% of items included in each of the selected combination of items have less than a threshold predicted availability at a retailer location operated by a corresponding retailer. The selection module 214 also may select a ranked set of combinations of items based on a rule describing a minimum or a maximum number of combinations of items that may be selected per retailer, or based on any other suitable factors.

The interface module 211 may send information describing ranked combinations of items determined for retailers to a customer client device 100 associated with a customer. In embodiments in which the selection module 214 selects a ranked set of combinations of items, the interface module 211 may send information describing the ranked set of combinations of items to the customer client device 100 associated with the customer. Information describing ranked combinations of items or a ranked set of combinations of items may describe the ranking and include various types of information describing each combination of items. For example, information describing a ranked set of combinations of items may describe the ranking based on an arrangement of the combinations of items, such that a highest ranked combination of items is in a top-most position of an ordering interface and a lowest ranked combination of items is in a bottom-most position of the ordering interface. In this example, the information also may describe a set of items included in each combination of items, a total price associated with each combination of items, a retailer associated with each combination of items, a set of items associated with each combination of items that is not available, and a set of replacement items. Furthermore, each combination of items may be presented with one or more options (e.g., to add the combination of items to a shopping list associated with a customer, to place an order including the combination of items, etc.).

To illustrate an example of information describing a ranked set of combinations of items, suppose that the interface module 211 sends information describing 10 of the top-ranked combinations of items to a customer client device 100 associated with a customer. In this example, the combinations of items may be arranged from left to right based on their ranking, such that information describing a combination of items in a left-most position is ranked first, information describing a combination of items in a second left-most position is ranked second, etc. Continuing with this example, the information describing each combination of items may include a name of a retailer for which the combination of items was determined and an image, a price, a brand, and a size of each item included in the combination of items. In the above example, the information also may indicate whether an item included in each combination of items is a replacement for another item that is not available and include information describing the item that is not available (e.g., its price, brand, size, etc.). In this example, the information also may include a total price associated with each combination of items, in which the total price includes tax and a delivery fee for an order that includes the combination of items. Continuing with this example, the information describing each combination of items may be presented in association with a button (e.g., an “Add” button) that provides the customer with an option to add the combination of items to a shopping list associated with the customer by interacting with the button.

Once the interface module 211 sends information describing ranked combinations of items or information describing a ranked set of combinations of items to a customer client device 100 associated with a customer, the data collection module 200 subsequently may receive information from the customer client device 100 describing a set of interactions by the customer with one or more of the combinations of items. For example, the data collection module 200 may receive information from a customer client device 100 associated with a customer describing whether the customer added a combination of items determined for a retailer to a shopping list associated with the customer or placed an order including the combination of items with the retailer. In this example, the data collection module 200 also may receive information describing each combination of items presented to the customer (e.g., information identifying the retailer associated with the combination of items, descriptions of one or more items included in the combination of items, a total price associated with the combination of items, a ranking associated with the combination of items, etc.). The data collection module 200 may then store the information describing the set of interactions in the data store 240 in association with customer data for the customer. Furthermore, the information describing the set of interactions may be used by the item combination determination model (described below) to learn from outcomes associated with the combinations of items.

The query understanding module 215 generates a prompt to a large language model (LLM). The LLM is a trained deep-learning model (e.g., GPT-4) that generates a textual output based on the prompt. In some embodiments, the LLM is trained by the machine learning training module 230, which is described below. The prompt generated by the query understanding module 215 may include a free-text query describing one or more items included among one or more inventories of one or more retailers associated with the online concierge system 140 and a set of constraints. The prompt also may include a request to identify the item(s) and the set of constraints included in the free-text query or any other suitable types of information. Examples of constraints that may be included in the free-text query include: a budget associated with the item(s), one or more attributes of the item(s) (e.g., sizes, brands, qualities, ingredients, materials, manufacturing locations, versions/varieties, etc.), a delivery timeframe, or any other suitable constraints. As a first example, if a free-text query states: “I want cookies and soda under $20,” a prompt generated by the query understanding module 215 may state: “Identify any items and constraints in the following query: ‘I want cookies and soda under $20.’” As a second example, if a free-text query states: “I want to make Spaghetti Bolognese for two with organic ingredients for less than $30,” a prompt generated by the query understanding module 215 may state: “Identify any items and constraints in the following query: ‘I want to make Spaghetti Bolognese for two with organic ingredients for less than $30.’” As a third example, if a free-text query states: “I want oat milk and eggs,” a prompt generated by the query understanding module 215 may state: “Identify any items and constraints in the following query: ‘I want oat milk and eggs.’”

Once the query understanding module 215 generates a prompt to the LLM, the query understanding module 215 provides the prompt to the LLM, which generates a textual output based on the prompt. The query understanding module 215 subsequently may receive the textual output from the LLM, in which the textual output describes one or more items and a set of constraints included in a free-text query included in the prompt. In the first example above, the query understanding module 215 may receive a textual output from the LLM that states: “Items: 1) Cookies and 2) Soda; Constraints: 1) Cost limit $20.” In the second example above, the query understanding module 215 may receive a textual output from the LLM that includes items corresponding to ingredients for making Spaghetti Bolognese and the constraints described by the free-text query. In this example, the textual output may state: “Items: 1) Spaghetti, 2) Ground beef, 3) Tomato sauce, 4) Garlic, 5) Onion, 6) Olive oil, 7) Italian herbs, 8) Salt, 9) Black pepper, and 10) Parmesan cheese; Constraints: 1) Serving two people, 2) Using organic ingredients, and 3) Staying within a $30 budget.” In the third example above, the query understanding module 215 may receive a textual output from the LLM that states: “Items: 1) Oat milk and 2) Eggs; Constraints: None.”

Once the query understanding module 215 receives a textual output from the LLM, the query understanding module 215 may extract, from the textual output, a set of constraints and one or more item categories, in which the item category/categories is/are associated with one or more items described in the textual output. The query understanding module 215 may do so by applying NLP techniques to the textual output or by using any other suitable technique or combination of techniques. In the first example above, the query understanding module 215 may extract, from the textual output, item categories corresponding to “cookies” and “soda” and a constraint corresponding to a budget of $20. In the second example above, the query understanding module 215 may extract, from the textual output, item categories corresponding to “spaghetti,” “ground beef,” “tomato sauce,” “garlic,” “onion,” “olive oil,” “Italian herbs,” “salt,” “black pepper,” and “parmesan cheese,” and constraints corresponding to a serving size of two, organic items, and a budget of $30. In the third example above, the query understanding module 215 may extract, from the textual output, item categories corresponding to “oat milk” and “eggs” and no constraints.

The combination determination module 216 may identify retailers associated with the online concierge system 140 with which a customer may place an order. The combination determination module 216 may do so based on customer data associated with the customer or information associated with the retailers. For example, the combination determination module 216 may identify a customer's favorite or preferred retailers, as well as retailers with which the customer may place an order that may be delivered to the customer within the customer's default delivery timeframe and that operate retailer locations within a threshold distance of the customer's default delivery location. The combination determination module 216 also may identify the retailers based on one or more item categories or constraints extracted by the query understanding module 215, predicted availabilities of items, picker data associated with pickers, or any other suitable types of information. For example, suppose that an item category extracted by the query understanding module 215 corresponds to sunscreen and that constraints extracted by the query understanding module 215 indicate that the sunscreen should be of a specific quality (e.g., SPF 50 or higher) and include a specific ingredient (e.g., zinc oxide). In this example, the combination determination module 216 may identify each item associated with the item category that satisfies the constraints and predict its availability at various retailer locations within a threshold distance of a location (e.g., a delivery location) associated with a customer, as further described below. Continuing with this example, the combination determination module 216 may identify retailers that operate retailer locations at which the items are most likely to be available. Furthermore, in the above example, if a retailer requires a membership to shop at its retailer locations, the combination determination module 216 also may identify the retailers based on picker data describing whether pickers available to service an order for the customer have the membership, such that the retailer may not be identified if the pickers do not have the membership.

For each retailer identified by the combination determination module 216, the combination determination module 216 may identify a set of items associated with each item category included among one or more item categories extracted by the query understanding module 215, in which the set of items is included among an inventory of a corresponding retailer.

For example, suppose that a retailer is included among multiple retailers identified by the combination determination module 216. In this example, suppose also that item categories corresponding to “orange juice” and “chocolate chip cookies” are extracted by the query understanding module 215. In this example, the combination determination module 216 may identify all items included in the “orange juice” item category and all items included in the “chocolate chip cookies” item category (e.g., all brands, sizes, prices, etc.), in which the identified items are included among an inventory of the retailer.

For each retailer identified by the combination determination module 216, the combination determination module 216 also may determine a set of combinations of items for a corresponding retailer, in which each combination of items includes a subset of the set of items associated with each item category included among the one or more item categories described above. The combination determination module 216 may do so based on a set of constraints extracted by the query understanding module 215. For example, suppose that item categories extracted by the query understanding module 215 correspond to “champagne,” “steak,” and “lobster” and that a constraint extracted by the query understanding module 215 is a budget of $200. In this example, once the combination determination module 216 identifies a set of items associated with each item category included among an inventory of a retailer, the combination determination module 216 may determine every combination of items that stays within the budget of $200, in which each combination includes an item associated with each item category.

In embodiments in which a single item category is extracted by the query understanding module 215, a combination of items may include a single item.

The combination determination module 216 also may determine a set of combinations of items for a retailer based on additional types of information, such as a predicted availability of an item. The combination determination module 216 may predict an availability of an item using the availability model described above. In some embodiments, if the predicted availability of an item associated with an item category is less than a threshold predicted availability, the combination determination module 216 identifies a substitute for the item and determines a combination of items that includes the substitute. For example, suppose that an item category extracted by the query understanding module 215 corresponds to chicken broth, that a constraint extracted by the query understanding module 215 describes a first brand of chicken broth, and that a predicted availability of the first brand of chicken broth at a retailer location is less than a threshold predicted availability. In this example, suppose that a second brand of chicken broth identified by the combination determination module 216 has a predicted availability at the retailer location that is at least the threshold predicted availability. In this example, the combination determination module 216 may determine a combination of items for a retailer that operates the retailer location, in which the combination of items includes the second brand of chicken broth as a substitute for the first brand of chicken broth. In other embodiments, if the predicted availability of an item associated with an item category is less than a threshold predicted availability, the combination determination module 216 determines a combination of items that includes neither the item, nor a substitute for the item (e.g., if any substitutes for the item also have less than the threshold predicted availability).

The combination determination module 216 may determine a set of combinations of items for a retailer using an item combination determination model. An item combination determination model is a machine learning model (e.g., a reinforcement learning model) that is trained to determine a set of combinations of items that includes a subset of a set of items associated with each of one or more item categories and that satisfies a set of constraints. The item combination determination model may determine a set of combinations of items for a retailer based on information describing one or more item categories, information describing a set of constraints, item data describing items included among an inventory of the retailer, or any other suitable types of information. For example, to determine a set of combinations of items for a retailer, the combination determination module 216 may access and apply the item combination determination model to one or more item categories and a set of constraints extracted by the query understanding module 215 and item data describing items included among an inventory of the retailer. In this example, the combination determination module 216 may then receive an output from the item combination determination model describing a set of combinations of items determined for the retailer, in which each combination of items includes a subset of a set of items associated with each item category of the item category/categories and satisfies the set of constraints. In some embodiments, the item combination determination model is trained by the machine learning training module 230 (described below).

In some embodiments, the item combination determination model is a reinforcement learning model. In such embodiments, the item combination determination model learns from outcomes associated with combinations of items (e.g., whether customers subsequently perform conversions with respect to the combinations of items). For example, a positive value may be assigned to an outcome corresponding to an addition of a highest ranked combination of items presented to a customer to a shopping list, while a negative value may be assigned to an outcome corresponding to an absence of the addition of the highest ranked combination of items presented to the customer to the shopping list. In this example, the item combination determination model may learn an optimal behavior that maximizes the values assigned to the outcomes. Continuing with the above example, the item combination determination model may learn that a customer adds combinations of items to their shopping list most frequently if the combinations include particular brands of items, if the combinations of items are determined for particular retailers, etc.

The order management module 220 manages orders for items from customers. The order management module 220 receives orders from customer client devices 100 and assigns the orders to pickers for service based on picker data. For example, the order management module 220 assigns an order to a picker based on the picker's location and the retailer location from which the ordered items are to be collected. The order management module 220 may also assign an order to a picker based on how many items are in the order, a vehicle operated by the picker, the delivery location, the picker's preferences for how far to travel to deliver an order, the picker's ratings by customers, or how often a picker agrees to service an order.

In some embodiments, the order management module 220 determines when to assign an order to a picker based on a delivery timeframe requested by the customer who placed the order. The order management module 220 computes an estimated amount of time that it would take for a picker to collect the items for an order and deliver the ordered items to the delivery location for the order. The order management module 220 assigns the order to a picker at a time such that, if the picker immediately services the order, the picker is likely to deliver the order at a time within the timeframe. Thus, when the order management module 220 receives an order, the order management module 220 may delay in assigning the order to a picker if the timeframe is far enough in the future.

In various embodiments, to improve the efficiency with which orders are serviced, the order management module 220 includes multiple orders in a batch that are serviced together. Orders may be included in the same batch based on order data associated with the orders, such as retailers with which the orders are placed, delivery locations for the orders, delivery timeframes for the orders, numbers of items included in the orders, etc. For example, orders placed with the same retailer to be delivered to delivery locations within a threshold distance of each other within similar timeframes may be included in the same batch. In this example, the batch of orders may be assigned to the same picker who may collect the items included in all of the orders at once from the same retailer location and subsequently deliver the orders to their corresponding delivery locations.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit instructions to the picker client device 110 to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model is used by the machine learning model to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In situations in which the training example includes a label, the loss function is also based on the label for the training example. Some example loss functions include the mean square error function, the mean absolute error, the hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, picker data, rules, policies, rates, etc. for use by the online concierge system 140. In the above example, the rules and policies may describe how service fees, delivery fees, and taxes are computed and the rates may include a set of tax rates for a set of addresses, geographical regions, etc. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data.

DETERMINING AND RANKING COMBINATIONS OF ITEMS FOR RETAILERS BASED ON A FREE-TEXT QUERY

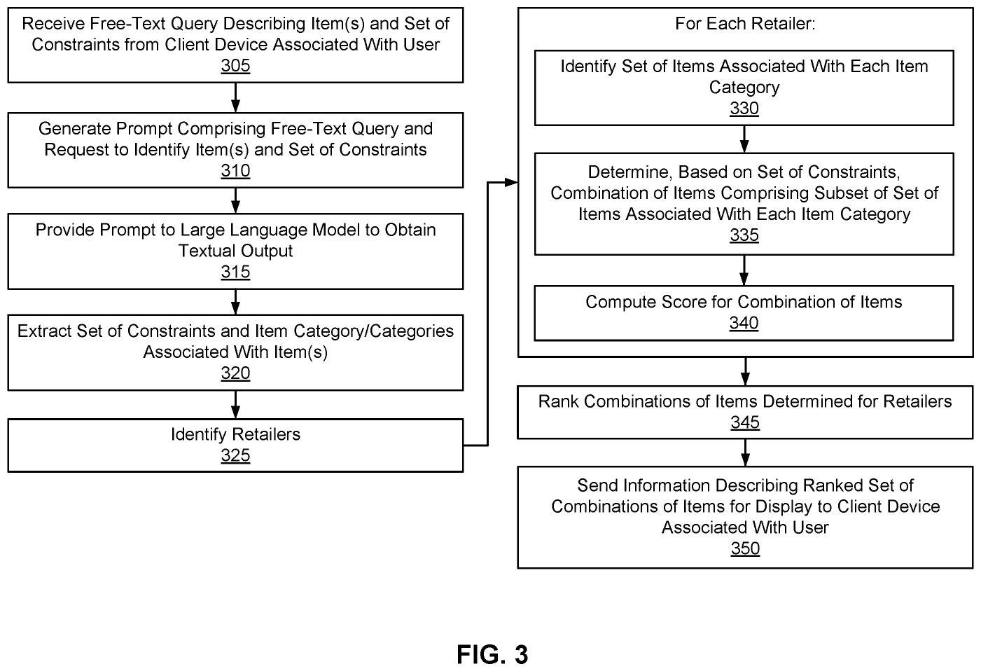

FIG. 3 is a flowchart of a method for determining and ranking combinations of items for retailers associated with an online concierge system 140 based on a free-text query, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system 140 without human intervention.

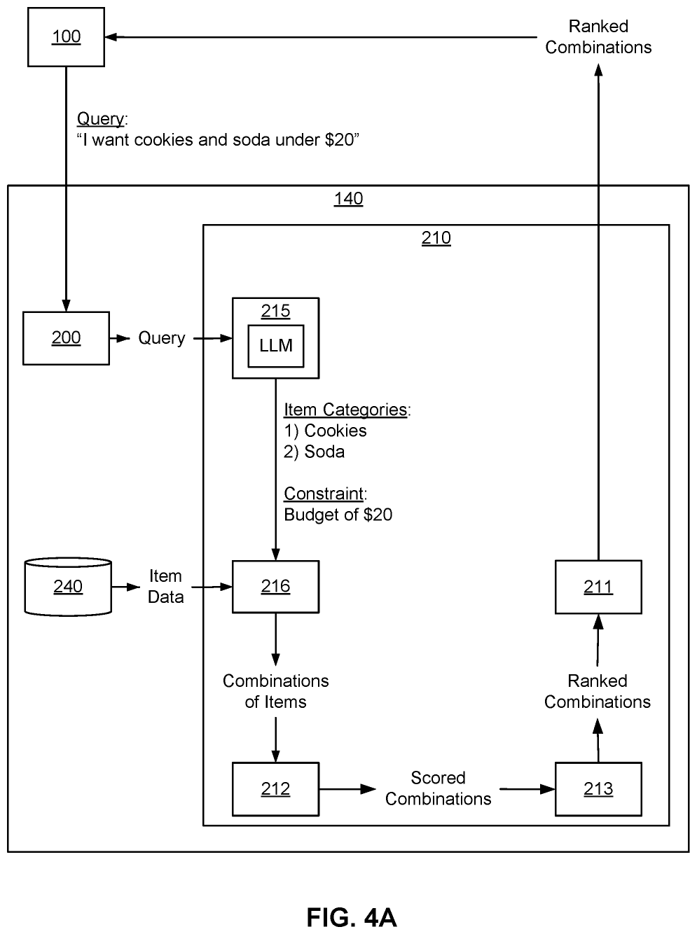

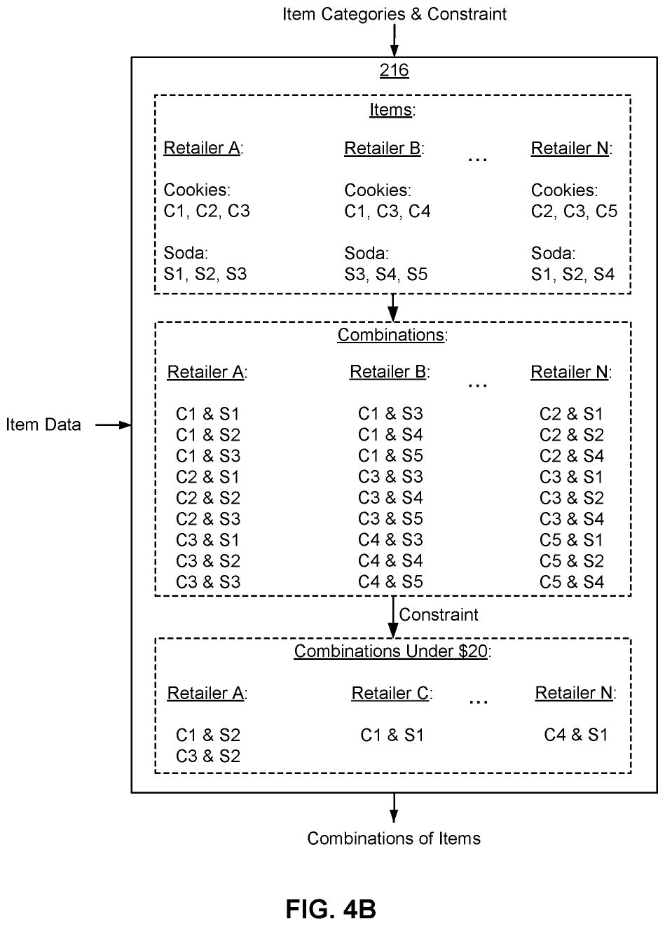

The online concierge system 140 receives 305 (e.g., via the data collection module 200) a free-text query from a customer client device 100 associated with a customer. The free-text query may describe one or more items included among one or more inventories of one or more retailers associated with the online concierge system 140 and a set of constraints. Examples of constraints that may be included in the free-text query include: a budget associated with the item(s), one or more attributes of the item(s) (e.g., sizes, brands, qualities, ingredients, materials, manufacturing locations, versions/varieties, etc.), a delivery timeframe, or any other suitable constraints. As a first example, the free-text query may state: “I want cookies and soda under $20,” as shown in the example of FIG. 4A, which is an interaction diagram for determining and ranking combinations of items for retailers associated with an online concierge system 140 based on a free-text query, in accordance with one or more embodiments. As a second example, the free-text query may state: “I want to make Spaghetti Bolognese for two with organic ingredients for less than $30.” As a third example, the free-text query may state: “I want oat milk and eggs.”

Referring back to FIG. 3, the online concierge system 140 may then generate 310 (e.g., using the query understanding module 215) a prompt to the LLM. As described above, the LLM is a trained deep-learning model (e.g., GPT-4) that generates a textual output based on the prompt. In some embodiments, the LLM is trained by the online concierge system 140 (e.g., using the machine learning training module 230). The prompt may include the free-text query received 305 from the customer client device 100, a request to identify the item(s) and the set of constraints included in the free-text query, or any other suitable types of information. In the first example above, the prompt generated 310 by the online concierge system 140 may state: “Identify any items and constraints in the following query: ‘I want cookies and soda under $20.’” In the second example, the prompt generated 310 by the online concierge system 140 may state: “Identify any items and constraints in the following query: ‘I want to make Spaghetti Bolognese for two with organic ingredients for less than $30.’” In the third example above, the prompt generated 310 by the online concierge system 140 may state: “Identify any items and constraints in the following query: ‘I want oat milk and eggs.’”

Once the online concierge system 140 generates 310 the prompt to the LLM, the online concierge system 140 provides 315 (e.g., via the query understanding module 215) the prompt to the LLM, which generates the textual output based on the prompt. The online concierge system 140 subsequently may receive (e.g., via the query understanding module 215) the textual output from the LLM, in which the textual output describes the item(s) and the set of constraints included in the free-text query. In the first example above, the textual output received from the LLM may state: “Items: 1) Cookies and 2) Soda; Constraints: 1) Cost limit $20.” In the second example above, the textual output received from the LLM may include items corresponding to ingredients for making Spaghetti Bolognese and the constraints described by the free-text query. In this example, the textual output may state: “Items: 1) Spaghetti, 2) Ground beef, 3) Tomato sauce, 4) Garlic, 5) Onion, 6) Olive oil, 7) Italian herbs, 8) Salt, 9) Black pepper, and 10) Parmesan cheese; Constraints: 1) Serving two people, 2) Using organic ingredients, and 3) Staying within a $30 budget.” In the third example above, the textual output received from the LLM may state: “Items: 1) Oat milk and 2) Eggs; Constraints: None.”

Once the online concierge system 140 receives the textual output from the LLM, the online concierge system 140 may extract 320 (e.g., using the query understanding module 215), from the textual output, the set of constraints and one or more item categories, in which the item category/categories is/are associated with the item(s) described in the textual output. The online concierge system 140 may do so by applying NLP techniques to the textual output or by using any other suitable technique or combination of techniques. In the first example above, the online concierge system 140 may extract 320, from the textual output, item categories corresponding to “cookies” and “soda” and a constraint corresponding to a budget of $20, as shown in FIG. 4A. In the second example above, the online concierge system 140 may extract 320, from the textual output, item categories corresponding to “spaghetti,” “ground beef,” “tomato sauce,” “garlic,” “onion,” “olive oil,” “Italian herbs,” “salt,” “black pepper,” and “parmesan cheese,” and constraints corresponding to a serving size of two, organic items, and a budget of $30. In the third example above, the online concierge system 140 may extract 320, from the textual output, item categories corresponding to “oat milk” and “eggs” and no constraints.

Referring again to FIG. 3, the online concierge system 140 may then identify (step 325, e.g., using the combination determination module 216) retailers associated with the online concierge system 140 with which the customer may place an order. The online concierge system 140 may do so based on customer data associated with the customer or information associated with the retailers. For example, the online concierge system 140 may identify 325 the customer's favorite or preferred retailers, as well as retailers with which the customer may place an order that may be delivered to the customer within the customer's default delivery timeframe and that operate retailer locations within a threshold distance of the customer's default delivery location. The online concierge system 140 also may identify 325 the retailers based on the item category/categories or the set of constraints, predicted availabilities of items, picker data associated with pickers, or any other suitable types of information. For example, suppose that an item category extracted 320 by the online concierge system 140 corresponds to sunscreen and that constraints extracted 320 by the online concierge system 140 indicate that the sunscreen should be of a specific quality (e.g., SPF 50 or higher) and include a specific ingredient (e.g., zinc oxide). In this example, the online concierge system 140 may identify (e.g., using the combination determination module 216) each item associated with the item category that satisfies the constraints and predict its availability at various retailer locations within a threshold distance of a location (e.g., a delivery location) associated with the customer, as further described below. Continuing with this example, the online concierge system 140 may identify (step 325) retailers that operate retailer locations at which the items are most likely to be available. Furthermore, in the above example, if a retailer requires a membership to shop at its retailer locations, the online concierge system 140 also may identify 325 the retailers based on picker data describing whether pickers available to service an order for the customer have the membership, such that the retailer may not be identified 325 if the pickers do not have the membership.

For each retailer identified 325 by the online concierge system 140, the online concierge system 140 may identify 330 (e.g., using the combination determination module 216) a set of items associated with each item category included among the item category/categories, in which the set of items is included among an inventory of a corresponding retailer. FIG. 4B illustrates an example of determining combinations of items for retailers associated with an online concierge system 140 based on a free-text query, in accordance with one or more embodiments. As shown in the example of FIG. 4B, which continues the example discussed above with respect to FIG. 4A, suppose that multiple retailers (Retailer A-N) are identified 325 by the online concierge system 140. In this example, for each retailer, the online concierge system 140 may identify 330 all items (e.g., all brands, sizes, prices, etc. of the items) included in the “cookies” item category and the “soda” item category, in which the identified (step 330) items are included among an inventory of the retailer. In this example, three items (C1, C2, and C3) in the “cookies” item category and three items (S1, S2, and S3) in the “soda” item category are identified 330 for Retailer A, three items (C1, C3, and C4) in the “cookies” item category and three items (S3, S4, and S5), in the “soda” item category are identified 330 for Retailer B, etc.

Referring again to FIG. 3, for each retailer identified 325 by the online concierge system 140, the online concierge system 140 also may determine 335 (e.g., using the combination determination module 216) a set of combinations of items for a corresponding retailer, in which each combination of items includes a subset of the set of items associated with each item category included among the item category/categories. The online concierge system 140 may determine 335 the set of combinations of items for each retailer based on the set of constraints. For example, as shown in FIG. 4B, for each retailer, the online concierge system 140 may determine 335 every combination of items included in the “cookies” and “soda” item categories that stays within the budget of $20, in which each combination includes an item associated with each item category. In this example, two combinations of items (C1 and S2, and C3 and S2) are determined 335 for Retailer A, no combinations of items are determined 335 for Retailer B, one combination of items (C1 and S1) is determined 335 for Retailer C, etc. In embodiments in which a single item category is extracted 320 by the online concierge system 140, a combination of items may include a single item.

The online concierge system 140 also may determine 335 the set of combinations of items for each retailer based on additional types of information, such as a predicted availability of an item. The online concierge system 140 may predict (e.g., using the combination determination module 216) an availability of an item using the availability model described above. In some embodiments, if the predicted availability of an item associated with an item category is less than a threshold predicted availability, the online concierge system 140 identifies (e.g., using the combination determination module 216) a substitute for the item and determines 335 a combination of items that includes the substitute. For example, suppose that an item category extracted 320 by the online concierge system 140 corresponds to chicken broth, that a constraint extracted 320 by the online concierge system 140 describes a first brand of chicken broth, and that a predicted availability of the first brand of chicken broth at a retailer location is less than a threshold predicted availability. In this example, suppose that a second brand of chicken broth identified 330 by the online concierge system 140 has a predicted availability at the retailer location that is at least the threshold predicted availability. In this example, the online concierge system 140 may determine 335 a combination of items for a retailer that operates the retailer location, in which the combination of items includes the second brand of chicken broth as a substitute for the first brand of chicken broth. In other embodiments, if the predicted availability of an item associated with an item category is less than a threshold predicted availability, the online concierge system 140 determines 335 a combination of items that includes neither the item, nor a substitute for the item (e.g., if any substitutes for the item also have less than the threshold predicted availability).

The online concierge system 140 may determine 335 a set of combinations of items for a retailer using an item combination determination model. An item combination determination model is a machine learning model (e.g., a reinforcement learning model) that is trained to determine 335 a set of combinations of items that includes a subset of a set of items associated with each of one or more item categories and that satisfies a set of constraints. The item combination determination model may determine 335 a set of combinations of items for a retailer based on information describing the item category/categories, information describing the set of constraints, item data describing items included among an inventory of the retailer, or any other suitable types of information. For example, to determine 335 a set of combinations of items for a retailer, the online concierge system 140 may access (e.g., using the combination determination module 216) and apply (e.g., using the combination determination module 216) the item combination determination model to the item category/categories and the set of constraints and item data describing items included among an inventory of the retailer. In this example, the online concierge system 140 may then receive (e.g., via the combination determination module 216) an output from the item combination determination model describing a set of combinations of items determined 335 for the retailer, in which each combination of items includes a subset of a set of items associated with each item category of the item category/categories and satisfies the set of constraints. In some embodiments, the item combination determination model is trained by the online concierge system 140 (e.g., using the machine learning training module 230).

In some embodiments, the item combination determination model is a reinforcement learning model. In such embodiments, the item combination determination model learns from outcomes associated with combinations of items (e.g., whether customers subsequently perform conversions with respect to the combinations of items). For example, a positive value may be assigned to an outcome corresponding to an addition of a highest ranked combination of items presented to a customer to a shopping list, while a negative value may be assigned to an outcome corresponding to an absence of the addition of the highest ranked combination of items presented to the customer to the shopping list. In this example, the item combination determination model may learn an optimal behavior that maximizes the values assigned to the outcomes. Continuing with the above example, the item combination determination model may learn that a customer adds combinations of items to their shopping list most frequently if the combinations include particular brands of items, if the combinations of items are determined 335 for particular retailers, etc.

Referring back to FIG. 3, for each retailer identified 325 by the online concierge system 140, the online concierge system 140 computes 340 (e.g., using the scoring module 212) a score for each combination of items determined 335 for a corresponding retailer, in which the score indicates a likelihood of conversion by the customer for the combination of items. For example, a score for a combination of items determined 335 for a retailer may indicate a likelihood that the customer will add the combination of items to a shopping list associated with the customer for the retailer or place an order including the combination of items with the retailer. The online concierge system 140 may compute 340 a score for a combination of items determined 335 for a retailer based on a set of customer data associated with the customer, a set of item data associated with each item included in the combination of items, or any other suitable types of information. For example, suppose that based on customer data associated with the customer and item data associated with items included in a first combination of items determined 335 for a first retailer, the first combination of items includes popular items, sale items, and the customer's favorite brands of items, and the first retailer is one of the customer's preferred retailers. In the above example, suppose also that based on the customer data associated with the customer and item data associated with items included in a second combination of items determined 335 for a second retailer, the second combination of items does not include popular items, sale items, or any of the customer's favorite brands of items, and the second retailer is not one of the customer's preferred retailers. Continuing with the above example, based on the customer data associated with the customer and the item data associated with each item included among the combinations of items, the online concierge system 140 may compute 340 a higher score for the first combination of items determined 335 for the first retailer than for the second combination of items determined 335 for the second retailer.

In some embodiments, the online concierge system 140 may compute 340 a score for a combination of items determined 335 for a retailer using the item selection model described above. To do so, the online concierge system 140 may use the item selection model to predict a likelihood of conversion by the customer for each item included in the combination of items based on a set of customer data associated with the customer, a set of item data associated with the item, or any other suitable types of information. The online concierge system 140 may then compute 340 the score for the combination of items based on the predicted likelihood associated with each item. For example, the online concierge system 140 may apply (e.g., using the scoring module 212) the item selection model to a set of preferences and an order history associated with the customer and a brand, an item category, a price, a name of a retailer, etc. associated with an item included in a combination of items. In this example, the online concierge system 140 may then receive (e.g., via the scoring module 212) an output from the item selection model describing a predicted likelihood that the customer will add the item to a shopping list associated with the customer for the retailer. Continuing with this example, the online concierge system 140 may repeat this process for each additional item included in the combination of items. In the above example, the online concierge system 140 may then compute (e.g., using the scoring module 212) a score for each item that is proportional to the likelihood predicted for the item and compute 340 a score for the combination of items by aggregating the scores for the items (e.g., as an average or a sum). Alternatively, in the above example, the online concierge system 140 may aggregate (e.g., using the scoring module 212) the likelihoods predicted for the items (e.g., as an average or a sum) and compute 340 the score for the combination of items based on the aggregated predicted likelihoods, such that the score is proportional to the aggregate.

In embodiments in which the item selection model uses item embeddings describing items and customer embeddings describing customers to score items, the online concierge system 140 computes 340 a score for a combination of items determined 335 for a retailer using the embeddings. The online concierge system 140 may compute (e.g., using the scoring module 212) a customer embedding for the customer (e.g., using a machine learning model) based on a set of customer data associated with the customer (e.g., information describing the customer's household, default delivery location and delivery timeframe, dietary preferences/restrictions, order and interaction history, favorite items and retailers, etc.). Similarly, the online concierge system 140 may compute (e.g., using the scoring module 212) an item embedding for each item included in a combination of items determined 335 for a retailer (e.g., using a machine learning model) based on a set of item data associated with the item (e.g., an item category, a price, a brand, etc. associated with the item, information describing the retailer that operates a retailer location at which the item is available, etc.). The online concierge system 140 may then determine (e.g., using the scoring module 212) a measure of similarity between the customer embedding and the item embedding for each item included in the combination of items (e.g., based on a cosine similarity, a Euclidean distance, a dot product, etc.), aggregate (e.g., using the scoring module 212) the measures of similarity, and compute 340 the score for the combination of items based on the aggregate. For example, the online concierge system 140 may compute a dot product of the customer embedding and the item embedding for each of three items included in a combination of items determined 335 for a retailer and compute a sum of the three dot products. In this example, the online concierge system 140 may compute 340 the score for the combination of items based on the sum, such that the score is proportional to the sum.

The online concierge system 140 also may compute 340 a score for a combination of items determined 335 for a retailer based on a predicted availability of an item included among the combination of items. The online concierge system 140 may predict (e.g., using the scoring module 212) an availability of an item using the availability model described above and compute 340 a score for a combination of items based on the predicted availability of each item included in the combination of items. For example, to compute 340 a score for a combination of items determined 335 for a retailer, the online concierge system 140 may apply (e.g., using the scoring module 212) the availability model to item data associated with each item included in the combination of items to predict its availability at a retailer location operated by the retailer (e.g., a likelihood that the item is available at the retailer location or an estimated number of the item available at the retailer location). In this example, the online concierge system 140 may compute 340 the score for the combination of items based on the predicted availability of each item included in the combination of items (e.g., by weighting the score for each item based on its predicted availability and aggregating the weighted scores).

Additionally, the online concierge system 140 may compute 340 a score for a combination of items determined 335 for a retailer based on whether a replacement item is included among the combination of items. For example, suppose that an item category extracted 320 by the online concierge system 140 corresponds to “organic celery” and that a combination of items determined 335 for a retailer includes non-organic celery as a substitute item. In this example, the online concierge system 140 may compute 340 a lower score for the combination of items than it would if the combination of items were to include an item associated with the “organic celery” item category since the combination of items includes a substitute item. Alternatively, in the above example, if the combination of items does not include an item associated with the “organic celery” item category or a substitute (e.g., if a substitute is not available), the online concierge system 140 may compute 340 an even lower score for the combination of items determined 335 for the retailer.

The online concierge system 140 also may compute 340 a score for a combination of items determined 335 for a retailer based on a total price associated with the combination of items. A total price associated with a combination of items may include various values, such as a sum of the prices of the items, an amount of tax on the items, a service fee, a delivery fee, a tip amount, etc. The online concierge system 140 may compute (e.g., using the scoring module 212) a total price associated with a combination of items based on item data associated with each item included in the combination of items (e.g., a price of each item, information describing a retailer location at which each item is available, etc.) and customer data associated with the customer (e.g., an address, a geographical region, or a delivery location associated with the customer). The online concierge system 140 also may compute a total price associated with a combination of items based on a set of rules, policies, rates, etc. (e.g., stored in the data store 240) describing how service fees, delivery fees, and taxes are computed, or based on any other suitable types of information.

To illustrate an example of how the online concierge system 140 may compute 340 a score for a combination of items determined 335 for a retailer based on a total price associated with the combination of items, suppose that the online concierge system 140 computes the total price as a sum of: the prices of the items, an amount of tax on the items, a service fee, a delivery fee, and a tip amount. In this example, the prices of the items may be determined based on item data associated with the items, while the amount of tax may be computed based on a sum of the prices of the items and a tax rate for an address/geographical region associated with the customer or a retailer location operated by the retailer. In the above example, the service fee or the delivery fee may be computed based on various factors, such as a distance between a delivery location associated with the customer and a retailer location operated by the retailer, the sum of the prices, the price of any additional items included in a shopping list associated with the customer for the retailer, etc., which may be proportional to the service fee or the delivery fee. Continuing with this example, if the service fee or the delivery fee may be lower for orders that may be included in a batch than for orders that may not be included in a batch, the service fee or the delivery fee also may be computed based on whether an order including the combination of items may be included in a batch. In this example, the tip amount (e.g., a percentage or a dollar amount) may correspond to or be computed based on a suggested tip amount or a default tip amount specified by the customer data associated with the customer. Continuing with the above example, the online concierge system 140 may then compute 340 the score for the combination of items based on the total price, such that the score is inversely proportional to the total price.

The online concierge system 140 may then rank 345 (e.g., using the ranking module 213) the combinations of items determined 335 for the retailers. As shown in FIG. 4A, the online concierge system 140 may do so based on scores computed 340 for the combinations of items. For example, the online concierge system 140 may rank 345 the combinations of items based on their scores, such that a combination of items with a highest score is ranked 345 first, a combination of items with a second-highest score is ranked 345 second, etc. The online concierge system 140 also may rank 345 the combinations of items determined 335 for the retailers based on additional factors. In some embodiments, the online concierge system 140 ranks 345 the combinations of items based on a weight applied to a score associated with a combination of items. The online concierge system 140 may weight (e.g., using the ranking module 213) a score for a combination of items based on whether an order including the combination of items may be included in a batch of orders. For example, if an order may be included in a batch of orders if it includes a first combination of items determined 335 for a first retailer, but not if it includes a second combination of items determined 335 for a second retailer, the online concierge system 140 may weight a score for the first combination of items more heavily than a score for the second combination of items.

Once the online concierge system 140 ranks 345 the combinations of items determined 335 for the retailers, the online concierge system 140 may select (e.g., using the selection module 214) a ranked set of the combinations of items. The online concierge system 140 may do so based on the ranking (e.g., the top n combinations of items or the p percentile of combinations of items). The online concierge system 140 also may select the ranked set of the combinations of items based on predicted availabilities of items included in each combination of items, which may be determined by the online concierge system 140, as described above. Based on the predicted availabilities, the online concierge system 140 may determine (e.g., using the selection module 214) a percentage of items included in each combination of items determined 335 for a corresponding retailer associated with at least a threshold predicted availability at a retailer location operated by the retailer. The online concierge system 140 may then select a ranked set of the combinations of items based on the percentage. For example, the online concierge system 140 may select five of the top-ranked combinations of items determined 335 for the retailers, in which less than 10% of items included in each of the selected combination of items have less than a threshold predicted availability at a retailer location operated by a corresponding retailer. The online concierge system 140 also may select a ranked set of the combinations of items based on a rule describing a minimum or a maximum number of combinations of items that may be selected per retailer, or based on any other suitable factors.

Referring once more to FIG. 3, the online concierge system 140 may then send 350 (e.g., via the interface module 211) information describing the ranked combinations of items determined 335 for the retailers to the customer client device 100 associated with the customer, as also shown in FIG. 4A. In embodiments in which the online concierge system 140 selects a ranked set of the combinations of items, the online concierge system 140 may send 350 information describing the ranked set of the combinations of items to the customer client device 100 associated with the customer. The information describing the ranked combinations of items or the ranked set of the combinations of items may describe the ranking and include various types of information describing each combination of items. For example, the information may describe the ranking based on an arrangement of the combinations of items, such that a highest ranked combination of items is in a top-most position of an ordering interface and a lowest-ranked combination of items is in a bottom-most position of the ordering interface. In this example, the information also may describe a set of items included in each combination of items, a total price associated with each combination of items, a retailer associated with each combination of items, a set of items associated with each combination of items that is not available, and a set of replacement items. Furthermore, each combination of items may be presented with one or more options (e.g., to add the combination of items to a shopping list associated with the customer, to place an order including the combination of items, etc.).

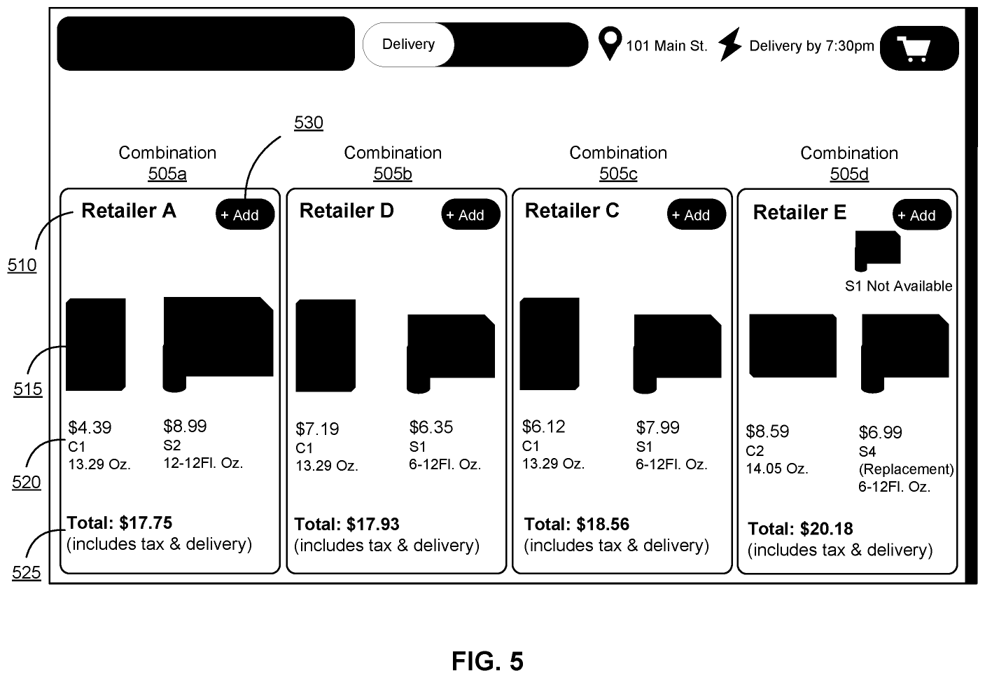

FIG. 5, which continues the example described above with respect to FIGS. 4A and 4B, illustrates an example of a ranked set of combinations 505 of items, in accordance with one or more embodiments. In this example, suppose that the online concierge system 140 sends 350 information describing four of the top-ranked combinations 505a-d of items to the customer client device 100 associated with the customer. In this example, the combinations 505a-d of items may be arranged from left to right based on their ranking, such that information describing a combination 505a of items in a left-most position is ranked 345 first, information describing a combination 505b of items in a second left-most position is ranked 345 second, etc. Continuing with this example, the information describing each combination 505 of items may include a name of a retailer 510 for which the combination 505 of items was determined 335 and an image 515 and a description 520 of each item included in the combination 505 of items (e.g., its price, brand, and size). In the above example, the information also may indicate that item S4 included in combination 505d of items is a replacement for item S1 that is not available. In this example, the information also may include a total price 525 associated with each combination 505 of items, in which the total price 525 includes tax and a delivery fee for an order that includes the combination 505 of items. Continuing with this example, the information describing each combination 505 of items may be presented in association with a button 530 (e.g., an “Add” button) that provides the customer with an option to add the combination 505 of items to a shopping list associated with the customer by interacting with the button 530.

Once the online concierge system 140 sends 350 the information describing the ranked combinations 505 of items or information describing a ranked set of the combinations 505 of items to the customer client device 100 associated with the customer, the online concierge system 140 subsequently may receive (e.g., via the data collection module 200) information from the customer client device 100 describing a set of interactions by the customer with one or more of the combinations 505 of items. For example, the online concierge system 140 may receive information from the customer client device 100 associated with the customer describing whether the customer added a combination 505 of items determined 335 for a retailer 510 to a shopping list associated with the customer or placed an order including the combination 505 of items with the retailer 510. In this example, the online concierge system 140 also may receive information describing each combination 505 of items presented to the customer (e.g., information identifying the retailer 510 associated with the combination 505 of items, descriptions 520 of one or more items included in the combination 505 of items, a total price 525 associated with the combination 505 of items, a ranking associated with the combination 505 of items, etc.). The online concierge system 140 may then store the information describing the set of interactions (e.g., in the data store 240) in association with customer data for the customer. Furthermore, the information describing the set of interactions may be used by the item combination determination model to learn from outcomes associated with the combinations 505 of items.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method, performed at a computer system comprising a processor and a computer-readable medium, comprising:
receiving, at an online concierge system, a free-text query from a client device associated with a user of the online concierge system, wherein the free-text query describes one or more items included among one or more inventories of one or more retailers associated with the online concierge system and a set of constraints;
generating a prompt comprising the free-text query and a request to identify the one or more items and the set of constraints;
providing the prompt to a large language model to obtain a textual output;
extracting, from the textual output, the set of constraints and one or more item categories associated with the one or more items;
identifying a plurality of retailers based at least in part on a set of user data associated with the user;
for each retailer of the plurality of retailers:
identifying a set of items associated with each item category of the one or more item categories, wherein the set of items is included among an inventory of a corresponding retailer,
identifying, based at least in part on the set of constraints, a combination of items comprising a subset of the set of items associated with each item category of the one or more item categories, and
generating a score for the combination of items based at least in part on the set of user data associated with the user and a set of item data associated with each item included in the combination of items, wherein the score indicates a likelihood of conversion by the user for the combination of items;
ranking a plurality of combinations of items determined for the plurality of retailers based at least in part on the score computed for each combination of items; and
sending information describing a ranked set of the plurality of combinations of items for display to the client device associated with the user, wherein the sending causes the client device to display the ranked set of the plurality of combinations of items.

2. The method of claim 1, wherein generating the score for the combination of items comprises:
generating a user embedding for the user based at least in part on the set of user data associated with the user;
generating an item embedding for each item included in the combination of items based at least in part on the set of item data associated with a corresponding item;
generating a dot product of the user embedding and the item embedding for each item included in the combination of items;
aggregating the dot product of the user embedding and the item embedding for each item included in the combination of items; and
generating the score for the combination of items based at least in part on the aggregated dot product of the user embedding and the item embedding for each item included in the combination of items.

3. The method of claim 1, wherein sending the information describing the ranked set of the plurality of combinations of items comprises sending one or more of: a set of items included in each combination of items, a total price associated with each combination of items, a retailer associated with each combination of items, a set of items associated with each combination of items that is not available, or a set of replacement items.

4. The method of claim 1, wherein identifying a plurality of retailers based at least in part on a set of user data comprises identifying a plurality of retailers based at least in part on one or more of: a preference of the user for each retailer of the plurality of retailers, a preference of the user for an attribute of an item, an order history associated with the user, or a location associated with the user.

5. The method of claim 1, wherein extracting the set of constraints comprises extracting a budget.

6. The method of claim 1, wherein generating the score for the combination of items comprises:
generating a total price associated with the combination of items based at least in part on the set of item data associated with each item included in the combination of items; and
generating the score for the combination of items based at least in part on the total price associated with the combination of items.

7. The method of claim 6, wherein the total price associated with the combination of items is further based at least in part on a delivery fee associated with an order including the combination of items.

8. The method of claim 1, wherein generating the score for the combination of items comprises:
predicting an availability of each item included in the combination of items at a retailer location associated with a corresponding retailer based at least in part on the set of item data associated with each item included in the combination of items; and
generating the score for the combination of items based at least in part on the predicted availability of each item.

9. The method of claim 8, further comprising:
determining a percentage of items included in the combination of items associated with at least a threshold predicted availability at the retailer location; and
selecting the ranked set of the plurality of combinations of items based at least in part on the percentage of items included in the combination of items associated with at least the threshold predicted availability at the retailer location.

10. The method of claim 1, wherein sending the information describing the ranked set of the plurality of combinations of items further causes the client device to display an option to add each combination of items to a shopping list associated with the user.

11. A computer program product comprising a non-transitory computer-readable storage medium having instructions encoded thereon that, when executed by a processor, cause the processor to perform steps comprising:
receiving, at an online concierge system, a free-text query from a client device associated with a user of the online concierge system, wherein the free-text query describes one or more items included among one or more inventories of one or more retailers associated with the online concierge system and a set of constraints;
generating a prompt comprising the free-text query and a request to identify the one or more items and the set of constraints;
providing the prompt to a large language model to obtain a textual output;
extracting, from the textual output, the set of constraints and one or more item categories associated with the one or more items;
identifying a plurality of retailers based at least in part on a set of user data associated with the user;
for each retailer of the plurality of retailers:
identifying a set of items associated with each item category of the one or more item categories, wherein the set of items is included among an inventory of a corresponding retailer,
identifying, based at least in part on the set of constraints, a combination of items comprising a subset of the set of items associated with each item category of the one or more item categories, and
generating a score for the combination of items based at least in part on the set of user data associated with the user and a set of item data associated with each item included in the combination of items, wherein the score indicates a likelihood of conversion by the user for the combination of items;
ranking a plurality of combinations of items determined for the plurality of retailers based at least in part on the score computed for each combination of items; and
sending information describing a ranked set of the plurality of combinations of items for display to the client device associated with the user, wherein the sending causes the client device to display the ranked set of the plurality of combinations of items.

12. The computer program product of claim 11, wherein generating the score for the combination of items comprises:
generating a user embedding for the user based at least in part on the set of user data associated with the user;
generating an item embedding for each item included in the combination of items based at least in part on the set of item data associated with a corresponding item;
generating a dot product of the user embedding and the item embedding for each item included in the combination of items;
aggregating the dot product of the user embedding and the item embedding for each item included in the combination of items; and
generating the score for the combination of items based at least in part on the aggregated dot product of the user embedding and the item embedding for each item included in the combination of items.

13. The computer program product of claim 11, wherein sending the information describing the ranked set of the plurality of combinations of items comprises sending one or more of: a set of items included in each combination of items, a total price associated with each combination of items, a retailer associated with each combination of items, a set of items associated with each combination of items that is not available, or a set of replacement items.

14. The computer program product of claim 11, wherein identifying a plurality of retailers based at least in part on a set of user data comprises identifying a plurality of retailers based at least in part on one or more of: a preference of the user for each retailer of the plurality of retailers, a preference of the user for an attribute of an item, an order history associated with the user, or a location associated with the user.

15. The computer program product of claim 11, wherein extracting the set of constraints comprises extracting a budget.

16. The computer program product of claim 11, wherein generating the score for the combination of items comprises:
generating a total price associated with the combination of items based at least in part on the set of item data associated with each item included in the combination of items; and
generating the score for the combination of items based at least in part on the total price associated with the combination of items.

17. The computer program product of claim 16, wherein the total price associated with the combination of items is further based at least in part on a delivery fee associated with an order including the combination of items.

18. The computer program product of claim 11, wherein generating the score for the combination of items comprises:
predicting an availability of each item included in the combination of items at a retailer location associated with a corresponding retailer based at least in part on the set of item data associated with each item included in the combination of items; and
generating the score for the combination of items based at least in part on the predicted availability of each item.

19. The computer program product of claim 18, wherein the computer-readable storage medium further has instructions encoded thereon that, when executed by the processor, cause the processor to perform steps comprising:
determining a percentage of items included in the combination of items associated with at least a threshold predicted availability at the retailer location; and
selecting the ranked set of the plurality of combinations of items based at least in part on the percentage of items included in the combination of items associated with at least the threshold predicted availability at the retailer location.

20. A computer system comprising:
a processor; and
a non-transitory computer-readable storage medium storing instructions that, when executed by the processor, perform actions comprising:
receiving, at an online concierge system, a free-text query from a client device associated with a user of the online concierge system, wherein the free-text query describes one or more items included among one or more inventories of one or more retailers associated with the online concierge system and a set of constraints;
generating a prompt comprising the free-text query and a request to identify the one or more items and the set of constraints;
providing the prompt to a large language model to obtain a textual output;
extracting, from the textual output, the set of constraints and one or more item categories associated with the one or more items;
identifying a plurality of retailers based at least in part on a set of user data associated with the user;
for each retailer of the plurality of retailers:
identifying a set of items associated with each item category of the one or more item categories, wherein the set of items is included among an inventory of a corresponding retailer,
identifying, based at least in part on the set of constraints, a combination of items comprising a subset of the set of items associated with each item category of the one or more item categories, and
generating a score for the combination of items based at least in part on the set of user data associated with the user and a set of item data associated with each item included in the combination of items, wherein the score indicates a likelihood of conversion by the user for the combination of items;
ranking a plurality of combinations of items determined for the plurality of retailers based at least in part on the score computed for each combination of items; and
sending information describing a ranked set of the plurality of combinations of items for display to the client device associated with the user, wherein the sending causes the client device to display the ranked set of the plurality of combinations of items.
